(19) United States
(12) Patent Application Publication
(10) Pub. No.: US 2024/0119834 A1
(43) Pub. Date: Apr. 11, 2024

(54) Automotive Drone Reconnaissance, Navigation, and Emergency Assistance

(71) Applicant: Panasonic Automotive Systems Company of America, Division of Panasonic Corporation of North America, PEACHTREE CITY, GA (US)

(72) Inventor: NICHOLAS BRIAN HANSEN, FAYETTEVILLE, GA (US)

(21) Appl. No.: 18/480,546

(22) Filed: Oct. 4, 2023

Related U.S. Application Data
(60) Provisional application No. 63/413,870, filed on Oct. 6, 2022.

(51) Int. Cl. G08G 1/0968; B64U 80/86; G08G 1/0967

(52) U.S. Cl. CPC G08G 1/096811; B64U 80/86; G08G 1/096766; B64U 2101/30

(57) ABSTRACT

An infotainment system for a motor vehicle includes a drone housed and carried by the vehicle. The drone flies away from the vehicle and collects information about an environment around the drone during the flight. A navigation system calculates a route for the vehicle to follow along roads in order to arrive at a destination. The calculating of the route is dependent upon the information collected by the drone.

### CROSS-REFERENCED TO RELATED APPLICATIONS

This application claims benefit of U.S. Provisional Application No. 63/413,870, filed on Oct. 6, 2022, the disclosure of which is hereby incorporated by reference in its entirety for all purposes.

### BACKGROUND OF THE INVENTION

### 1. Field of the Invention

The present invention relates to an infotainment system of a motor vehicle.

### 2. Description of the Related Art

Drivers of motor vehicles often have an unmet need for information about the vehicle's immediate and extended environment due to lack of visibility. For example, a driver may be in a parking lot looking for the last parking spot or stuck in traffic wondering what is going on up ahead. The driver may need to plan their route around the next bend, which is not currently visible. The driver may be unsure if they have pulled all the way into a parking spot. The driver may have been in an accident and may need to know if it is safe to leave the vehicle, but cannot see what traffic is approaching the location of the accident.

Vehicles often have onboard cameras. Even with the emergence of camera systems on vehicles, the data collection is limited by the actual position and attitude of the vehicle. These cameras are relatively limited in their data collection capabilities due to their fixed locations.

Another problem is that drivers may be temporarily unable to communicate with the outside world due to the surrounding environment blocking their line of sight with communication towers or satellites. For example, the vehicle may be in a valley, and thus the driver may not be able to make contact in an emergency.

### SUMMARY OF THE INVENTION

The invention may provide a solution to the problems described above. The invention may provide the integration of a quadcopter or other form of drone into a vehicle's infotainment system. When a driver encounters a situation similar to the situations described above, the driver may choose to deploy a drone that has been “parked” in a protective charging housing located on the exterior of the vehicle to obtain a remote view from the drone. The drone may have one or more cameras or other sensors, which can be used to capture images of, and inspect, the environment external to the vehicle and relay the information back to the vehicle's infotainment system. The sensors may include visible light cameras, infrared cameras, LIDAR sensors, and microphones. The drone may be communicatively integrated into the vehicle's infotainment system and physically integrated into the vehicle such that, while the drone is “parked” in the vehicle, the vehicle can maintain the drone's batteries, protect the drone, and utilize the drone's cameras.

Signals from the drone may be processed to determine sizes and distances to objects and obstacles. The signals may also be processed to determine or evaluate the safety of a potential route. This information could then be presented on a head up display (HUD) or integrated center stack (ICS) display. The drone may be controlled via voice commands, steering wheel switches, ICS switches, or other switch banks.

The drone and the included cameras may be positioned to provide additional camera views even while “parked” on the vehicle and may function as an extension of the vehicle's existing camera system. Wide-angle lenses on the “parking” enclosure may enlarge the field of view.

The drone may also function as an antenna repeater. In the event the vehicle becomes stranded in an area with limited cellular service, the drone could be deployed and flown to a location with better reception and the connection to the vehicle could then be bridged with the improved connection.

The drone could also be used to signal emergency service vehicles or as an additional hazard indicator. Speakers and hazard lights on the drone could be used to alert other drivers to an emergency. It is also possible to utilize the drone as an audio device. Floodlights may be mounted on the drone to illuminate an accident scene or to aide in roadside repairs when it is dark.

The invention comprises, in one form thereof, an infotainment system for a motor vehicle, including a drone housed and carried by the vehicle. The drone flies away from the vehicle and collects information about an environment around the drone during the flight. A navigation system calculates a route for the vehicle to follow along roads in order to arrive at a destination. The calculating of the route is dependent upon the information collected by the drone.

The invention comprises, in another form thereof, a wireless communication system for a motor vehicle, including a wireless communication module that wirelessly communicates with wireless communication infrastructure. A drone is housed and carried by the vehicle. The drone flies away from the vehicle and relays wireless communication signals between the wireless communication module and the wireless communication infrastructure.

The invention comprises, in yet another form thereof, an infotainment system for a motor vehicle, including a drone communicatively coupled to an electronic processor. The drone is housed and carried by the vehicle. The drone flies away from the vehicle and captures an overhead image of a parking lot. The drone wirelessly transmits signals indicative of the captured overhead image to the electronic processor. A display screen is communicatively coupled to the electronic processor and displays images of the parking lot based on the signals transmitted from the drone to the electronic processor.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic side view of one embodiment of an automotive drone reconnaissance, navigation, and emergency assistance arrangement of the present invention.

FIG. 2 is a schematic side view of the drone of the automotive drone reconnaissance, navigation, and emergency assistance arrangement of FIG. 1.

FIG. 3 is a flow chart of one embodiment of a method of the invention for operating a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

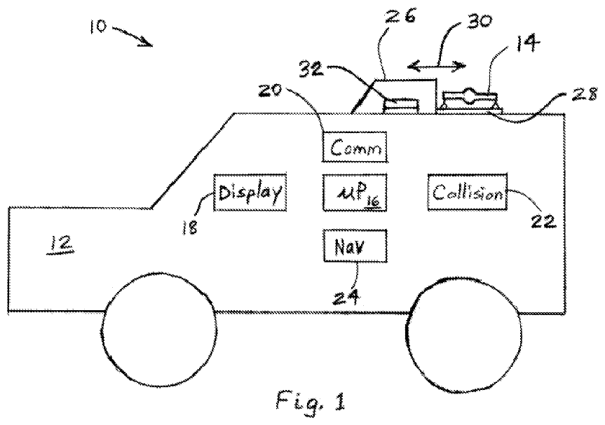

FIG. 1 illustrates one embodiment of an automotive drone reconnaissance, navigation, and emergency assistance arrangement 10 of the present invention, including a motor vehicle 12 and a drone 14. Vehicle 12 includes an electronic processor 16 communicatively coupled to each of a display screen 18, a wireless communication module 20, a collision detection system 22, and a navigation system 24. Communication module 20 may include antennas and other hardware and software necessary for wireless communication (e.g., cellular communication) with the outside world (e.g., information providers, emergency responders, etc.) and with drone 14.

Vehicle 12 also includes a parking enclosure or garage 26 for protecting drone 14 from wind, precipitation and dust when drone 14 is not getting ready to take off from launch/landing pad 28, in flight, or landing on launch/landing pad 28. Pad 28 may be slidable in and out of garage 26 in directions indicated by double arrow 30. Mounted within garage 26 are wide angle lenses 32.

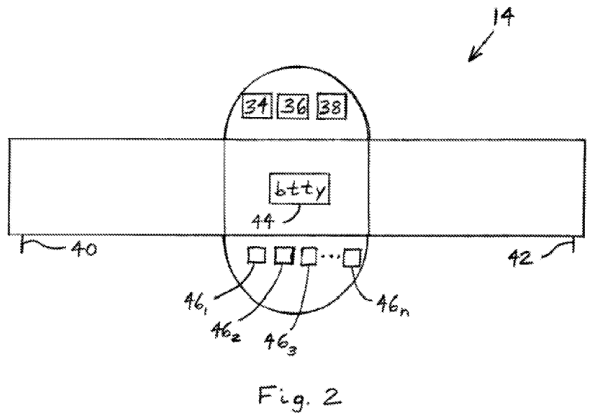

As shown in FIG. 2, drone 14 includes hazard lights 34, an antenna pack 36, a loudspeaker 38, positive magnetic contacts 40, negative magnetic contacts 42, a battery 44, and sensors 46₁₋ₐ which may include visible light cameras, infrared cameras, LIDAR sensors, microphones, thermometers, wind sensors, precipitation sensors, smoke detectors and carbon monoxide detectors, for example. When drone 14 is in garage 26, vehicle 12 may charge battery 44 through contacts 40, 42.

During use, drone 14 may be launched into the air whenever the driver or processor 16 determines that there is a need for drone 14 to collect or transmit information or to provide light. For example, there may be a need for drone 14 to transmit, collect or relay cellular or other wireless communications; capture images of the nearby environment, detect sounds and create audio signal reproductions of the detected sounds; or collect data from sensors that detect parameters of the nearby environment, such as temperature, air quality, and weather conditions.

In order to launch drone 14 from vehicle 12, launch/landing pad 28 may be actuated with a motor (not shown) to slide out of garage 26 with drone 14 being supported by pad 28 and sitting thereon. Drone 14 may then be in position to launch off of pad 28 and fly to locations where drone 14 can best perform its functions. Drone 14 may control its flight path autonomously, under the control of vehicle processor 16, under the control of the driver of vehicle 12, or under the control of some other remote entity, such as a governmental authority or private company that charges a fee to control drone 14 such that drone 14 can provide valuable data or relay wireless communications between vehicle 12 and some remote entity.

In one specific use case, drone 14 may perform reconnaissance ahead of vehicle 12 along the vehicle's planned route according to navigation system 24. Drone 14 may perform such reconnaissance routinely and/or autonomously, or may do so due to some specific circumstances that raise the probability that vehicle 12 may want to change its planned route. Such circumstances may include, for example, a reduction in the speed of vehicle 12; a change in weather conditions; an increase in the number of surrounding vehicles and/or a reduction in the spacing of surrounding vehicles (e.g., a traffic jam); other vehicles on the planned route being motionless (e.g., such as after a collision), having reduced speed, or being off of the road; or there being smoke detected by drone 14 along the planned route.

In another specific use case, drone 14 may function as a wireless signal repeater to enable vehicle 12 to wirelessly communicate with the outside world in the event that vehicle 12 is not a valley and its signal cannot be received by wireless communication infrastructure, such as a cellular tower or satellite. For example, if vehicle 12 has been in an accident or breakdown in a valley such that vehicle 12 cannot communicate with a cellular tower or satellite, drone 14 may hover above vehicle 12 at a height sufficient for drone 14 to communicate with a cellular tower or satellite as well as with vehicle 12. Drone 14 can then act as a go-between to relay signals between vehicle 12 and the cellular tower or satellite. Drone 14 may be automatically deployed to perform this relay function when needed, such as when collision sensor 22 detects a collision, but cannot establish a communication link with the outside world in order to summon emergency responders.

In yet another specific use case, drone 14 may capture overhead views of a parking lot in order to help the driver find an empty parking spot that minimizes the walking he must do to get to his destination. In one embodiment, a live overhead video of the parking lot is presented on display screen 18, and the driver looks at the video in order to decide where to drive to find a desirable empty spot. In another embodiment, processor 16 analyzes the captured overhead video in order to provide textual and/or audible driving directions to the driver to a desirable empty spot. In a further embodiment, processor 16 analyzes the captured overhead video in order to autonomously drive vehicle 12 to a desirable empty spot with the human driver having to do any of the driving.

The driver may issue a command or otherwise cause drone 14 to be slid out of garage 26 and to take flight to an elevation where drone 14 may capture images of the entire parking lot. In one embodiment, drone 14 may fly to a standard or predetermined elevation above vehicle 12 where an entire parking lot can generally be seen in captured images. In another embodiment, the images captured by drone 14 may be analyzed in real time by processor 16 or by drone 14 in order to identify the perimeter of the parking lot. With the location of the perimeter identified, the drone may then fly to an elevation and position where it may best capture images of the entire parking lot.

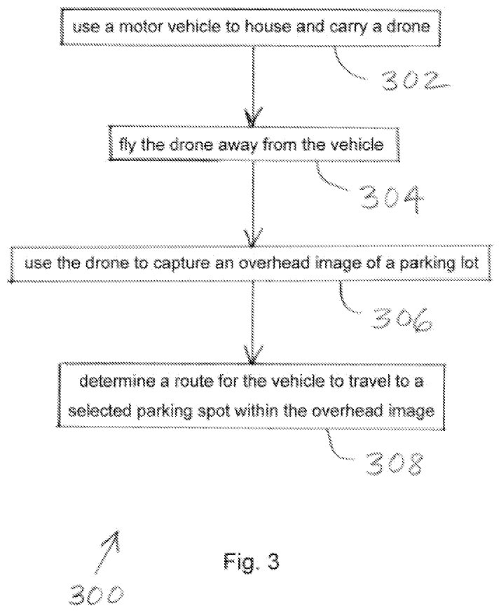

FIG. 3 illustrates one embodiment of a method 300 of the invention for operating a motor vehicle. In a first step 302, the motor vehicle is used to house and carry a drone. For example, motor vehicle 12 carries drone 14 and houses drone 14 in a garage 26.

Next, in step 304, the drone is flown away from the vehicle. For example, in order to launch drone 14 from vehicle 12, launch/landing pad 28 may be actuated with a motor to slide out of garage 26 with drone 14 being supported by pad 28 and sitting thereon. Drone 14 may then be in position to launch off of pad 28 and fly to locations where drone 14 can best perform its functions.

In a next step 306, the drone is used to capture an overhead image of a parking lot. For example, drone 14 may be controlled by a passenger of vehicle 12 to fly above a parking lot and capture an image of the parking lot with an onboard camera. As another example, drone 14 may use an electronic map of parking lot locations to navigate its flight to a location above a parking lot, where drone 14 may capture an image of the parking lot. It is also possible for navigation system 24 within vehicle 12 to access an electronic map and direct drone 14, via wireless signals, to a location above a parking lot, where drone 14 may capture an image of the parking lot.

In a final step 308, a route for the vehicle to travel to a selected parking spot within the overhead image is determined. For example, drone 14 may transmit a video signal of the parking lot image to vehicle 12, and processor 16 may identify an empty parking spot or parking space within the parking lot that vehicle 12 can get to most quickly, or that is closest to vehicle 12. Navigation system 24 may then plan a route for vehicle 12 to travel in order to arrive at the selected parking spot.

The inventive drone has been described above as communicating with the processor, display screen, communications module, collision sensor and/or navigation system of vehicle 12. It is to be understood that the inventive drone may also communicate with a mobile phone or other personal electronic device that can perform the same functions as these components of vehicle 12.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An infotainment system for a motor vehicle, the system comprising:
a drone configured to:
be housed and carried by the vehicle; and
fly away from the vehicle and collect information about an environment around the drone during the flight; and
a navigation system configured to calculate a route for the vehicle to follow along roads in order to arrive at a destination, wherein the calculating of the route is dependent upon the information collected by the drone.

2. The system of claim 1 wherein the information collected by the drone includes images captured by the drone of a portion of roadway ahead of the vehicle.

3. The system of claim 1 wherein the information collected by the drone includes weather conditions.

4. The system of claim 1 wherein the drone is configured to illuminate the vehicle during its flight.

5. The system of claim 1 wherein the drone is configured to fly away from the vehicle in response to a change in speed of the vehicle or a change in a number of other vehicles within a threshold distance of the vehicle.

6. The system of claim 1 wherein the drone is configured to transmit the information collected by the drone to other nearby motor vehicles.

7. The system of claim 1 further comprising an enclosure on a body of the vehicle, the enclosure being configured to house the drone.

8. A wireless communication system for a motor vehicle, the system comprising:
a wireless communication module configured to wirelessly communicate with wireless communication infrastructure;
a drone configured to:
be housed and carried by the vehicle; and
fly away from the vehicle and relay wireless communication signals between the wireless communication module and the wireless communication infrastructure.

9. The system of claim 8 wherein the drone is configured to fly above the vehicle to a location where the drone can communicate with both the wireless communication module and the wireless communication infrastructure.

10. The system of claim 8 wherein the drone is configured to shine light on the vehicle during its flight.

11. The system of claim 8 wherein the drone is configured to fly away from the vehicle in response to the wireless communication module becoming unable to directly communicate with the wireless communication infrastructure.

12. The system of claim 8 further comprising a collision detection system, wherein the drone is configured to fly away from the vehicle in response to the collision detection system detecting that the vehicle has been in an accident.

13. The system of claim 8 further comprising an enclosure on a body of the vehicle, the enclosure being configured to house the drone.

14. The system of claim 13 wherein the enclosure includes a wide-angle lens, and the drone includes an image capturing device configured to capture images through the wide-angle lens while the drone is in the enclosure.

15. An infotainment system for a motor vehicle, the system comprising:
an electronic processor;
a drone communicatively coupled to the electronic processor and configured to:
be housed and carried by the vehicle;
fly away from the vehicle and capture an overhead image of a parking lot; and
wirelessly transmit signals indicative of the captured overhead image to the electronic processor; and
a display screen communicatively coupled to the electronic processor and configured to display images of the parking lot based on the signals transmitted from the drone to the electronic processor.

16. The system of claim 15 wherein the electronic processor is configured to analyze the signals transmitted from the drone in order to provide textual and/or audible driving directions to the driver to a selected parking spot.

17. The system of claim 15 wherein the electronic processor is configured to analyze the signals transmitted from the drone in order to autonomously drive the vehicle to a selected parking spot.

18. The system of claim 15 wherein the electronic processor is configured to:
analyze the signals transmitted from the drone to thereby locate boundaries of the parking lot; and
instruct the drone to fly to a location in three-dimensional space where the drone can capture the overhead image of the parking lot, the instructing of the drone being dependent upon the located boundaries of the parking lot.

19. The system of claim 15 wherein the drone is configured to:
analyze the captured overhead image of the parking lot to thereby locate boundaries of the parking lot; and
re-locate to a location in three-dimensional space where the drone can capture the overhead image of the parking lot, the re-locating of the drone being dependent upon the located boundaries of the parking lot.

20. The system of claim 15 further comprising an enclosure on a body of the vehicle, the enclosure being configured to house the drone.
